(19) United States
(12) Patent Application Publication
(10) Pub. No.: US 2013/0198006 A1
(43) Pub. Date: Aug. 1, 2013

(54) PROVIDING TARGETED CONTENT FOR MULTIPLE USERS

(71) Applicants: Soma Sundaram Santhiveeran, Fremont, CA (US); Ricardo Bueno Moreira, Porto Alegre (BR); Cristiane Karasek Wasielewski, Gravatai (BR); Gilson Hoffmeister, Novo Hamburgo (BR); Leonardo Alves Machado, Porto Alegre (BR); Walter Flores Pereira, Porto Alegre (BR); Gabriel Girardello Detoni, Sunnyvale, CA (US); Iara Rapaki Debom, Porto Alegre (BR)

(72) Inventors: Soma Sundaram Santhiveeran, Fremont, CA (US); Ricardo Bueno Moreira, Porto Alegre (BR); Cristiane Karasek Wasielewski, Gravatai (BR); Gilson Hoffmeister, Novo Hamburgo (BR); Leonardo Alves Machado, Porto Alegre (BR); Walter Flores Pereira, Porto Alegre (BR); Gabriel Girardello Detoni, Sunnyvale, CA (US); Iara Rapaki Debom, Porto Alegre (BR)

(21) Appl. No.: 13/361,016

(22) Filed: Jan. 30, 2012

(51) Int. Cl. G06Q 30/02

(52) U.S. Cl. 705/14.66

(57) ABSTRACT

Systems and methods for providing content are described. An image and a set of faces in the image are determined. Each face in the set of laces corresponds with a user of a display screen. For each face in the set, an identifier is determined, content targeted for the face is selected, a location of the face within the image is determined, and using the face location, a location on the display screen for providing a visualization of the targeted content is determined.

### I. BACKGROUND

Advertising is a tool for marketing goods and services, attracting customer patronage, or otherwise communicating a message to a widespread audience. The advertisements are typically presented through various types of media including, but not limited to, television, radio, print, billboard (or other outdoor signage), Internet, digital signage, mobile device screens, etc.

Digital signs, such as LED, LCD, plasma and projected images, can be found in public and private environments, such as retail stores and corporate locations. The components of a typical digital signage installation include display screen(s), media player(s), and a content management server. Sometimes two or more of these components are present in a single device but typically there is a display screen, a media player, and a content management server that is connected to the media player over a private network. One content management server may support multiple media players and one media player may support multiple screens.

Regardless of the media, whether it be via a digital sign or other media, advertisements are presented to the general public with the intention of commanding the attention of the audience and to induce prospective customers to purchase the advertised goods or service, or otherwise be receptive to the message being conveyed.

### II. BRIEF DESCRIPTION OF THE DRAWINGS

The present disclosure may be better understood and its numerous features and advantages made apparent by referencing the accompanying drawings.

FIG. 1 is a semi-perspective and semi-schematic diagram of a digital display system in accordance with an embodiment.

FIG. 2 is a topological block diagram of a system for providing targeted content for multiple users in accordance with an embodiment.

FIG. 3A is a process flow diagram for providing targeted content for multiple users in accordance with an embodiment.

FIG. 3B is a process flow diagram for determining an identifier of a detected face in accordance with an embodiment.

FIG. 3C is a process flow diagram for content selection in accordance with an embodiment.

FIG. 3D is a process flow diagram for location determination in accordance with an embodiment.

FIG. 4A is a diagram illustrating zone recognition in accordance with an embodiment.

FIG. 4B is another diagram illustrating zone recognition in accordance with an embodiment.

FIG. 4C is diagram illustrating zones of a display screen icy accordance with an embodiment.

FIG. 4D is a perspective diagram of a digital display system with multiple zones in accordance with an embodiment.

FIG. 5 is a perspective diagram of a digital display system with content displayed via fluid mapping in accordance with an embodiment.

FIG. 6A is a diagram illustrating zone configuration in accordance with an embodiment.

FIG. 6B is a diagram illustrating a two-dimensional zone, multiple display floor plan in accordance with an embodiment.

FIG. 7A is diagram illustrating three-dimensional zone, multiple display configuration in accordance with an embodiment.

FIG. 7B is a diagram illustrating a three-dimensional multiple display floor plan in accordance with an embodiment.

FIG. 8 illustrates a computer system in which an embodiment may be implemented.

### III. DETAILED DESCRIPTION

Conventional mass advertising, including digital signs, is a non-selective medium. As a consequence, it is difficult to reach a precisely defined market segment. The volatility of the market segment, especially with placement of digital signs in public settings, is heightened due to the changing variations in the composition of audiences. In many circumstances, the content may be selected and delivered for display by a digital sign based on a general understanding of the consumer tendencies considering time of day, geographic coverage, etc. For large scale deployments in public venues (e.g. malls, airports, hospitals, etc.), there are numerous simultaneous audience members within the immediate range. Typical digital signage implementations do not serve customized content to multiple users, which may make it difficult for the message to have its intended impact.

As described herein, systems and methods for providing targeted content to multiple users are provided. An image and a set of faces in the image are determined. Each face in the set of faces corresponds with a user of a display screen. For each face in the set, an identifier is determined, content targeted for the face is selected, a location of the face within the image is determined, and using the face location, a location on the display screen for providing a visualization of the targeted content is determined, such that targeted content is displayed close to the user or directly in front of the user.

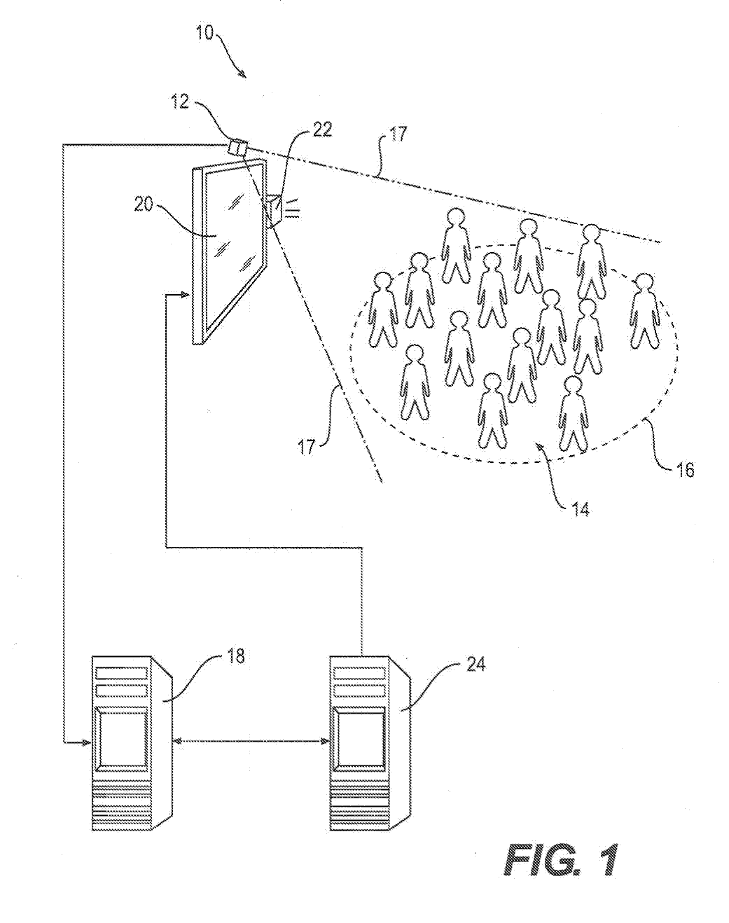

FIG. 1 is a semi-perspective and semi-schematic diagram of a digital display system 10 in accordance with an embodiment. The system includes at least one imaging device 12 (e.g. a camera) pointed at an audience 14 (located in an audience area 16 that represents at least a portion of the field of view of the imaging device), and a content computer 18, interconnected to the imaging device 12 and configured to provide targeted content for multiple users of the digital display system 10.

The content computer 18 is a video image analysis computing device that is configured to analyze visual images taken by the imaging device 12. The imaging device 12 can be configured to take video images (i.e. a series of sequential video frames that capture motion) at any desired frame rate, or it can take still images. The term “content computer” is used to refer to the computing device that is interconnected to the imaging device 12, and is not intended to limit the imaging device to a camera per se. A variety of types of imaging devices can be used. It should also be recognized that the term “computer” as used herein is to be understood broadly as referring to a personal computer, portable computer, content server, a network PC, a personal digital assistant (PDA), a cellular telephone or any other computing device that is capable of performing the functions for receiving input from and/or providing control or driving output to the various devices associated with the interactive display system.

The imaging device 12 is positioned near a changeable display device 20, such as a CRT, LCD screen, plasma display, LED display, display wall, projection display (front or rear projection) or other type of display device. For a digital signage application, this display device can be a large size public display, and can be a single display, or multiple individual displays that are combined together to provide a single composite image in a tiled display. This can include projected image(s) that can be tiled together or combined or superimposed in various ways to create a display. The display device can also be comprised of multiple independent displays, each corresponding to a region of an image. For example, system 10 may use a dedicated display for each zone. An audio broadcast device, such as an audio speaker 22, can also be positioned near the display to broadcast audio content along with the video content provided on the display.

The digital display system 10 also includes a display computer 24 that is interconnected to provide the desired video and/or audio output to the display 20 and the audio speaker 22. The content computer 18 is interconnected to the display computer 24, allowing feedback and analysis from the content computer 18 to be used by the display computer 24. The display computer 24 may also provide feedback to the video camera computer regarding camera settings to allow the change of focus, zoom, field of view, and physical orientation of the camera (e.g. pan, tilt, roll), if the mechanisms to do so are associated with the camera.

A single computer can be used to control both the imaging device 12 and the display 20. For example, the single computer can be programmed to handle all functions of video image analysis, content selection, determination of display coordinates and control of the imaging device, as well as controlling output to the display. For example, the content computer 18 is configured to perform the functions of display computer 24, in addition to its own functions. Moreover, content computer 18 and display computer 24 may be embedded into display 20, camera 12, or the functionalities thereof may be split between content computer 18 and display computer 24.

Additionally, the digital display system 10 can be a network or part of a network or it can be interconnected to a network. The network can be a local area network (LAN), or any other type of computer network, including a global web of interconnected computers and computer networks, such as the Internet.

The content computer 18 can be any type of personal computer, portable computer, or workstation computer that includes a processing unit, a system memory, and a system bus that couples the processing unit to the various components of the computer. The processing unit may include processor(s), each of which may be in the form of any one of various commercially available processors. Generally, each processor receives instructions and data from a read-only memory and/or a random access memory. The controller can also include a hard drive, a floppy drive, and CD ROM drive that are connected to the system bus by respective interfaces. The hard drive, floppy drive, and CD ROM drive contain respective computer-readable media disks that provide non-volatile or persistent storage for data, data structures and computer-executable instructions. Other computer-readable storage devices (e.g., magnetic tape drives, flash memory devices, and digital versatile disks) can also be used with the content computer 18.

The imaging device 12 is oriented toward an audience 14 of individual people, who are gathered in the audience area, designated by outline 16. While the audience area is shown as a definite outline having a particular shape, this is intended to represent that there is some area near the imaging device 12 in which an audience can be viewed. The audience area can be of a variety of shapes, and can comprise the entirety of the field of view 17 of the imaging device, or some portion of the field of view. For example, some individuals can be near the audience area and perhaps even within the field of view of the imaging device, and yet not be within the audience area that will be analyzed by the content computer 18.

In operation, the imaging device 12 captures an audience view, which may involve capturing a single snapshot or a series of frames/video. It can involve capturing a view of the entire camera field of view, or a portion of the field of view (e.g. a region, black/white vs. color, etc). Additionally, it is to be understood that multiple imaging devices can be used simultaneously to capture video images for processing.

Content computer 18 detects faces in the snapshot or frame. Any face or object detection methodology may be used. In certain deployments (e.g., public settings), the displays are becoming larger and often can serve multiple users at the same time. For example, the frame may include numerous people, some of whom might be looking away from the imaging device 12 and/or screen 20 or might be engaging in some other action which prevents the detection of faces. Where faces are detected, the content computer 18 determines the location of the face within the frame. For example, the camera coordinates of the face are determined.

For each face, the camera coordinates are used to determine where the targeted content is shown on the display screen of display 20. In order to increase the reachability of the content's message to the intended recipient (i.e., target audience member), the content is displayed within proximity to the intended recipient (e.g., in front of the recipient). The specific proximal location on the display 20 is determined by mapping the camera coordinates to display coordinates. In another embodiment, the specific proximal location on the display 20 is determined by identifying a zone within which the face is located, and using the corresponding zone in the display screen to present the content. Furthermore, the display 20 can serve targeted content to multiple audience members at the same time. For example, where the location of the audience members vary, specific content for each of the audience members may be displayed.

The display 20 (and the audio speaker 22) provides the selected content to the targeted audience members. The content can be in the form of commercial advertisements, entertainment, political advertisements, survey questions, or any other type of content.

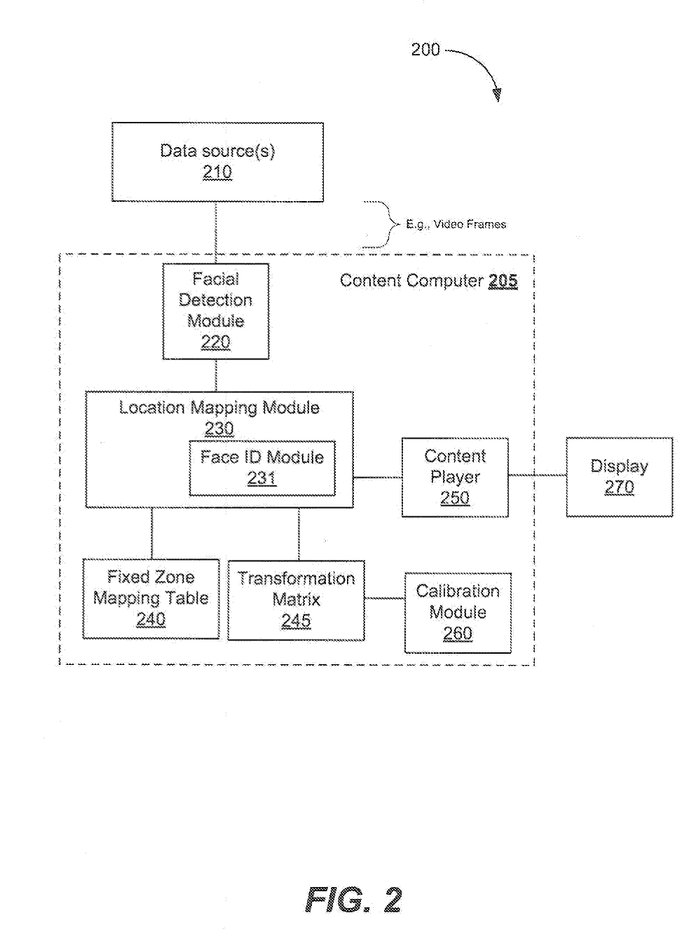

FIG. 2 is a topological block diagram of a system 200 for providing targeted content for multiple users in accordance with an embodiment. System 200 includes data source(s) 210. A data source is a device or application which provides a single snapshot, a series of frames (e.g., video frames), or a video stream, to a content computer 205.

System 200 further includes a content computer 205, which includes a facial detection module 220, a location mapping module 230, a fixed zone mapping table 240, a transformation matrix 245, a calibration module 260, and a content player 250.

The facial detection module 220 is configured to detect faces within a snapshot, a series of frames or a video stream (hereinafter, “frame”). Various methods of facial detection may be used. For example, facial detection begins by locating a face outline, a mouth, eyes, etc. The facial detection module 220 determines boundaries of the detected face, and extracts facial attributes.

The location mapping module 230 is operatively coupled to the facial detection module 220 and is configured to determine a unique identifier for the face (as calculated by a face identifier module 231), by tracking face boundaries between the frames and assigning unique identifiers. The bounding rectangle provides a rough location of the face within the frame. Furthermore, the location mapping module 230 is configured to determine the display region, in display pixel coordinates, that is closest to the audience member that corresponds to the detected face by using the transformation matrix 245, for example, to map camera coordinates of the bounding rectangle to correlating display pixel coordinates.

in another embodiment, location mapping module 230 is configured to determine the display region, in display pixel coordinates, using the fixed zone mapping table 240, for example, to map the user location (i.e., location of the face in the image) to a predefined zone in the display. More specifically, camera coordinates of the detected face are mapped to a fixed zone (“interaction zone”) in the display screen of display 270. Each zone services a distinct set of audience members, based on the location of the audience member's location (i.e., face location n the image captured by the data source 210). For example, a sample fixed zone mapping table is shown below:

TABLE 1
Fixed Zone Mapping Table

| Zone | Range of Camera coordinates | Range of Display Coordinates |
|---|---|---|
| 1 | (x₁, y₁) to (x₂, y₂) | (x′₁, y′₁) to (x′₂, y′₂) |
| 2 | (x₃, y₃) to (x₄, y₄) | (x′₃, y′₃) to (x′₄, y′₄) |
| 3 | (x₅, y₅) to (x₆, y₆) | (x′₅, y'₅) to (x′₆, y′₆) |

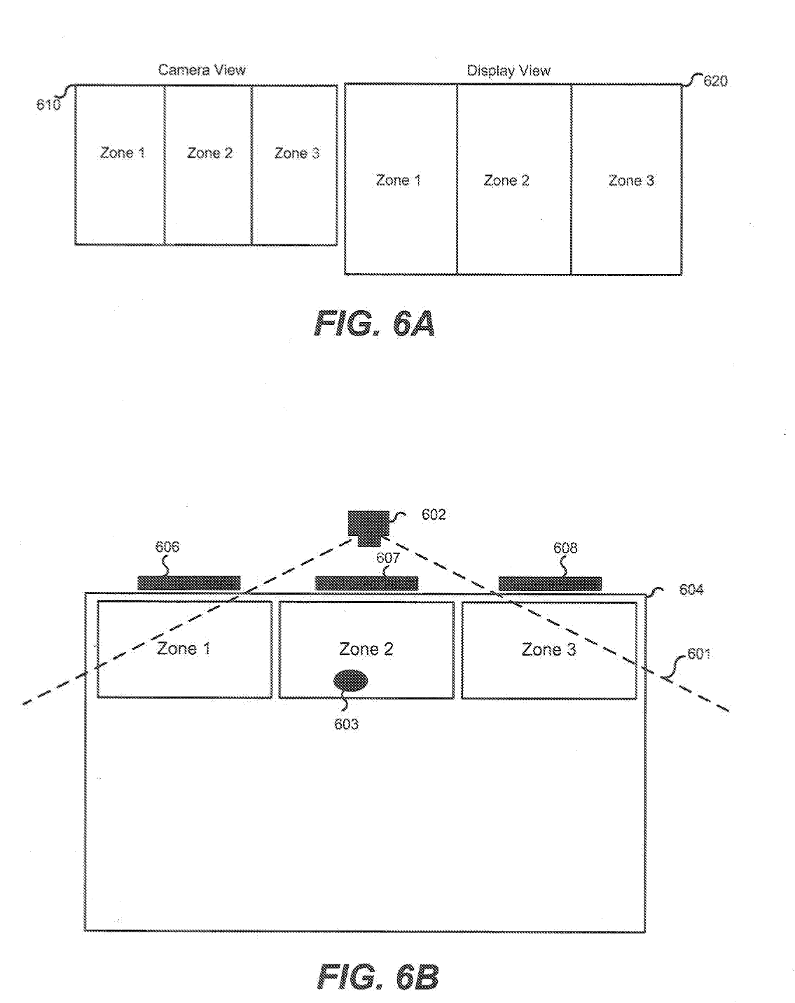

Using the fixed zone mapping table as shown, a camera coordinate (x₁, y₁) maps to zone 1 in the display. Zone 1 is defined in this example as being made up of the range (x′₁, y′₁) to (x′₂, y′₂) in display coordinates. When the content is actually displayed, it will be shown in zone 1 of the display screen. One methodology for defining the camera and display coordinates/zones is illustrated in FIG. 6A.

The calibration module 260 is operatively coupled to the transformation matrix 245 and the content player 250. Where the system 200 is configured to display content that is closest to the audience member, without any predefined zones, calibration module 260 is configured to calculate the transformation matrix 245 or a function to determine how an audience member's face (as seen by the data source, e.g., camera) is mapped to the display screen of display 270. Several methods may be used for such calculation, for example, using the relative size of the display and location, orientation and field of view of the camera or other image capture device.

The transformation matrix 245 may also be calculated by asking an audience member to step in front of a marker that is determined, for example, by the calibration module 260 and shown in the display screen of display 270. The markers may be displayed at known display pixel coordinates. The markers allow the system 200 to capture the audience member's image using, for example, a camera, locate the audience member's face on the camera image, and record the camera pixel coordinates. The display coordinates and the corresponding camera pixel coordinates are compared to calculate the transformation matrix 245 or function. In another embodiment, instead of stepping in front of the marker, the audience member may hold up a clearly recognizable object in front of the marker on the display.

The content player 250 is operatively coupled to the calibration module 260 and the location mapping module 230. The content player 250 is configured to receive display coordinates from the location mapping module 230 and send instruction to display 250 to show the selected content for a particular audience member in the zone or display region closest to the user.

The display 270 is operatively coupled to content player 250 and is configured to provide a visualization of the selected content in a location of the display screen specified by the display coordinates.

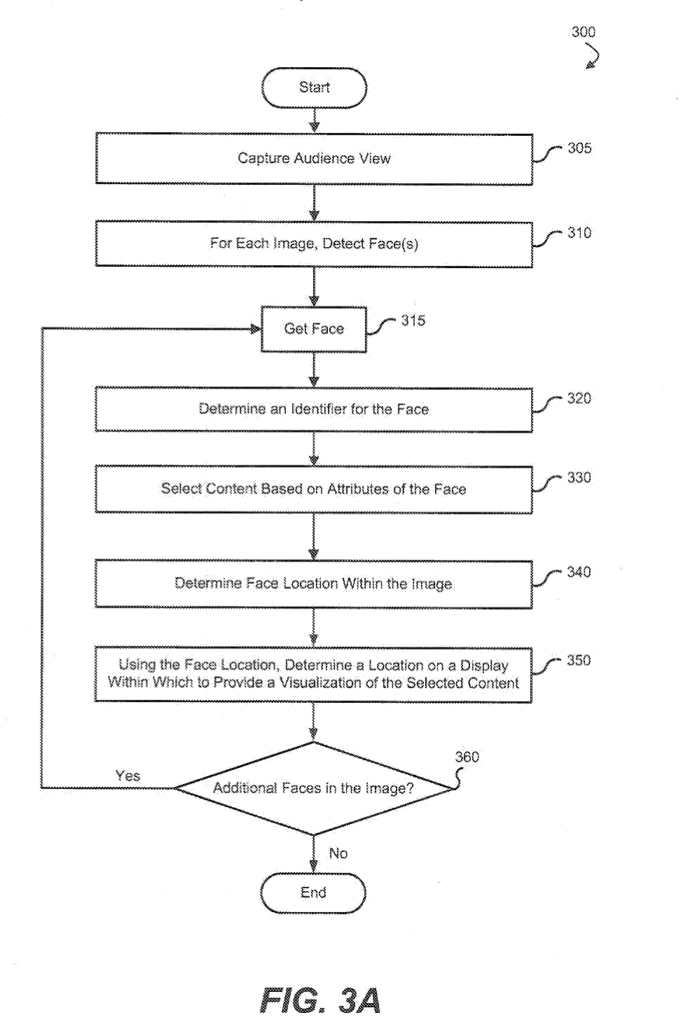

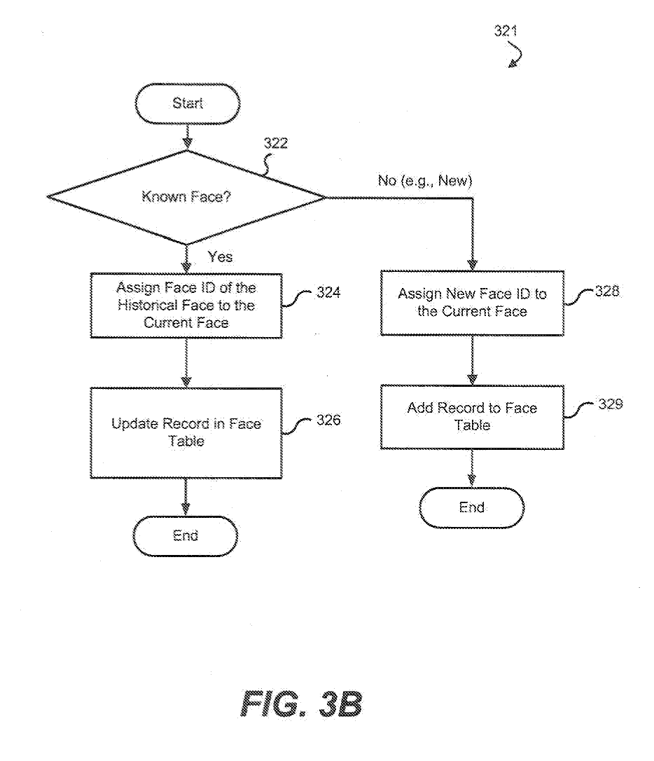

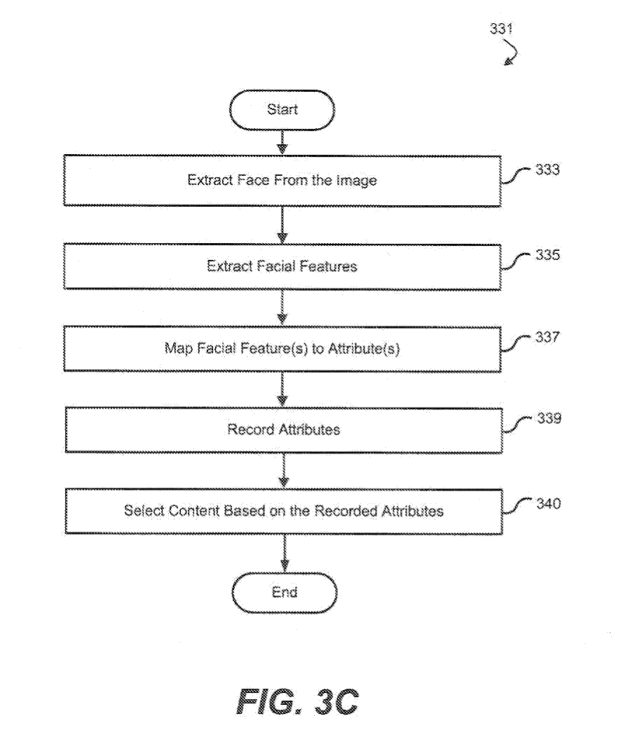

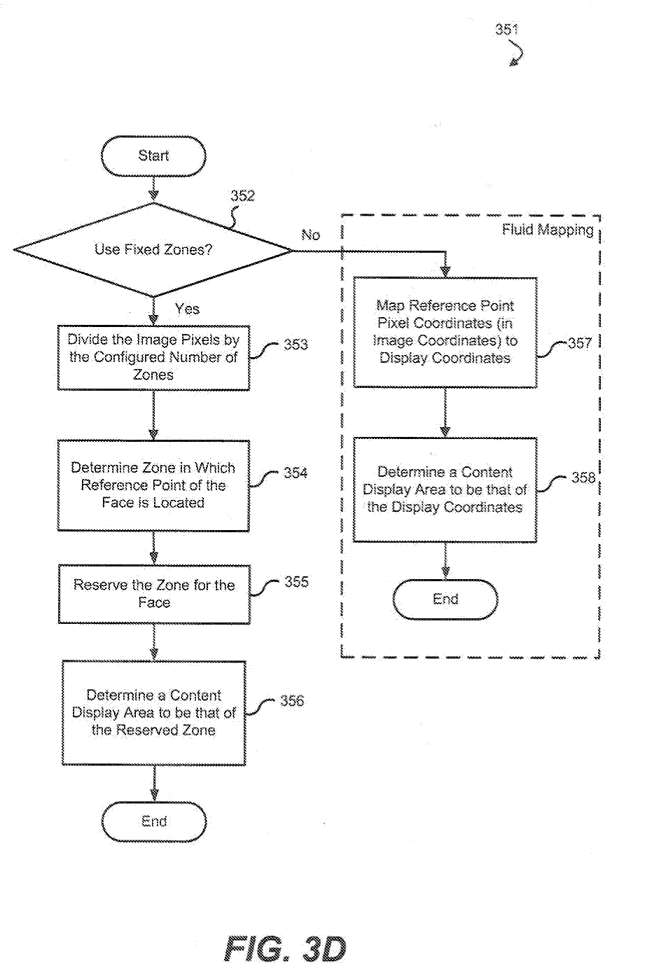

FIG. 3A is a process flow diagram for providing targeted content for multiple users in accordance with an embodiment. The depicted process flow 300 may be carried out by execution of sequences of executable instructions. In another embodiment, various portions of the process flow 300 are carried out by components of a digital display system, an arrangement of hardware logic, e.g., an Application-Specific Integrated Circuit (ASIC), etc. For example, blocks of process flow 300 may be performed by execution of sequences of executable instructions in a content computer of the digital display system.

At step 305, an audience view is captured. For example, imaging device(s) may capture an image of the audience members who are gathered in an audience area. The image (e.g. frame) is provided to the content computer for further analysis. At step 310, for each image, facial detection is performed. Specifically, the boundaries of each detected face are determined, for example a bounding rectangle is generated. In one embodiment, facial attributes are determined in addition to the boundaries.

One of the faces in the image is retrieved, at step 315. An identifier for the face is determined at step 320. In one embodiment, each detected face is associated with a unique identifier. The identifier is used to track faces of audience members, for example, as they move across frames. Faces which have not been seen before receive a new identifier. On the other hand, if a detected face was previously seen, for example in the preceding frame, the identifier of the face in the preceding frame is assigned to the face in the current frame. The process of determining identifiers is further described with respect to FIG. 3B.

At step 330, content is selected. The content (e.g., multimedia content) may be stored in a repository and selected based on attributes of the detected face. The attributes may include such features as the age, gender, and ethnicity of the detected face. Content selection is further described with respect to FIG. 3C. At step 340, the location of the face within the image is determined. For example, the mid-point of the face in camera pixel coordinates is determined.

Using the face location, a location on the display screen within which to provide a visualization of the selected content is determined, at step 350. The location on the display may be determined in various manners. In one embodiment, a display screen is partitioned into multiple predefined zones. Each zone is slated to serve a distinct set of audience members, depending on the location of the audience member's face in the image. In other words, each facial location in an image maps to a particular zone in the display screen, such that the selected content is displayed specifically in that zone. The use of the zones enables the display screen to serve targeted content to multiple audience members at the same time. It should be noted that the process of selecting the content and determining the display screen location can occur in parallel. The display screen location can be determined before the content is actually selected. The selected content may then be presented to the user.

In another embodiment, the screen is not partitioned into zones, but rather, the display screen location is determined by directly mapping the camera coordinates to display coordinates. Specifically, the face location (in camera coordinates) is mapped to the corresponding display screen coordinates, such that the content is displayed closest to the audience member. This is another way to serve targeted content to multiple users at the same time. Determining the location on the display screen is further described with respect to FIG. 3D.

At step 360, it is determined whether there are additional faces in the image. If there are, processing continues back to step 315 where another face is retrieved and the display screen location is determined for that face. After all faces in the image have been analyzed, the process can repeat itself, whereby another image is received. The face table may be cleaned, for example by removing identifiers in the table for faces that are no longer present in the image.

FIG. 3B is a process flow diagram for determining an identifier of a detected face in accordance with an embodiment. The depicted process flow 321 may be carried out by execution of sequences of executable instructions. In another embodiment, various portions of the process flow 321 are carried out by components of a digital display system, an arrangement of hardware logic, e.g., an Application-Specific Integrated Circuit (ASIC), etc. For example, blocks of process flow 321 may be performed by execution of sequences of executable instructions in a content computer of the digital display system.

Each detected face is associated with a unique identifier. As previously described, the identifier can be used to track faces of audience members, for example, as they move across frames. To accomplish this, a face table may maintain records of historical (i.e., previously detected) faces. The face table includes the face identifier (“face ID”) and camera pixel coordinates (x₁, y₁, x₂, y₂) of the bounding rectangle associated with a detected face, e.g., the top left corner (x₁, y₁) and the lower right corner (x₂, y₂). The face table may include the camera pixel reference coordinates (x, y). The reference coordinates may be midpoint coordinates, which can be calculated in many ways using for example, the center of the face rectangle, nose, midpoint between the eyes, etc. For example, the midpoint coordinates may be calculated by the following: where x=(x₁+x₂)/2, and y=(y₁+y₂)/2. Furthermore, the face table may include values of various attributes of the detected face, as determined by facial analysis or detection methodologies. The attributes may include age or age group of the face, gender, ethnicity, etc. In another embodiment, the face table includes the ID of the content that is being played for the user and the location of the content in the display.

At step 322, it is determined whether a face is known. Specifically, it is determined whether the bounding rectangle of the current face significantly overlaps with a previously detected face. The rationale is that any movement of an audience member from one frame to the next frame should satisfy a minimum overlap threshold. If there is not enough overlap between the bounding rectangles in the current frame and a previous frame, it is unlikely that the audience member who corresponds with the current face is moving among the frames. Rather, it is more likely that the current face is that of a new audience member. The face table may be referenced to obtain the bounding rectangle coordinates of the previously detected faces.

In another embodiment, a unique signature may be calculated based on facial features and used to determine if a face is known or unknown. More specifically, a unique signature of the current face is determined, using the facial features. This unique signature of the current face is then compared to the unique signatures of historical faces. If there is a match between the signature of the current face with that of a historical face, it is determined that the face is known.

Where there is no match at step 322, it is determined the current face is a new face, and a new face ID is assigned at step 328. A new record is added to the face table, at step 329, to reflect the data of the new face, at step 329. For example, the face ID assigned at step 328 is recorded along with the bounding rectangle coordinates and/or reference coordinates.

One the other hand, where a match is determined at step 322, it is determined the same audience member has moved along a trajectory in real space. At step 324, the face ID of the matching historical face is assigned to the current face. Furthermore, at step 326, the record of the matching historical face is updated with the information of the current face. Specifically, the bounding rectangle coordinates and reference coordinates are updated in the face table to reflect the values of the current face.

As such, the audience member may be tracked among the images or frames. By doing so, the content may follow the trajectory of the targeted audience member when it is displayed. For example, if the audience member is associated initially with zone 1 and then moves to zone 2, the content selected for that member may be displayed in zone 2 (after initially being displayed in zone 1).

FIG. 3C is a process flow diagram for content selection in accordance with an embodiment. The depicted process flow 331 may be carried out by execution of sequences of executable instructions. In another embodiment, various portions of the process flow 331 are carried out by components of a digital display system, an arrangement of hardware logic, e.g., an Application-Specific Integrated Circuit (ASIC), etc. For example, blocks of process flow 331 may be performed by execution of sequences of executable instructions in a content computer of the digital display system.

The selection of content for specific targets may be performed in many ways. In one embodiment, the face image is extracted from the image/frame, at step 333. Various facial features may then be extracted, at step 335.

A facial pattern storage may be implemented to maintain a listing of facial attributes, such as age, gender, and ethnicity. The extracted facial features are mapped to attributes, at step 337. For example, the attributes of the face may be 30, female, Asian which correspond to the age, gender, and ethnicity attributes. At step 339, the attribute values of the face are recorded, for example in the face table. At step 340, content is selected based on the attributes. Various methods of content selection may be used. For example, certain advertisements may be targeted specifically for an age and gender group.

FIG. 3D is a process flow diagram for location determination in accordance with an embodiment. The depicted process flow 351 may be carried out by execution of sequences of executable instructions. In another embodiment, various portions of the process flow 351 are carried out by components of a digital display system, an arrangement of hardware logic, e.g., an Application-Specific Integrated Circuit (ASIC), etc. For example, blocks of process flow 351 may be performed by execution of sequences of executable instructions in a content computer of the digital display system.

The placement of the content on the display screen can impact the efficacy with which the content's message can reach the intended target. Moreover, multiple audience members are serviced with targeted content on a single display (e.g., large scale deployment such as a display wall) by selective placement of the content.

To determine the location on the display screen where the content will be presented, it is determined whether the digital display system is configured with fixed zones or fluid mapping, at step 352.

Fixed Zones

In one embodiment, the display screen is partitioned into Z number of zones, where each zone services a distinct set of audience members. At step 353, the display resolution is determined by dividing the total number of pixels in the image by the total number of zones Z.

At step 354, the system determines the zone in which the reference point of the face is located. For example, the midpoint of the face in camera pixel coordinates is determined, i.e., (x,y). The reference point coordinates (e.g., midpoint coordinates) map to a particular zone. For example, a fixed zone mapping table may include a mapping of ranges of camera coordinates to zones. It is determined which range the midpoint coordinates fall into, and the corresponding zone is identified. The zones may be partitioned in many ways, i.e., in various orientations, configurations, number of zones, etc.

In one embodiment, assuming the display screen is partitioned into Z horizontal zones, each one serving a distinct set of audience members, the display pixel coordinates along the x-axis for each zone may be determined by:

$${Z}_{w} = \frac{{D}_{h}}{Z}$$

$${Z}_{ID} = INT ( \frac{{D}_{x}}{{Z}_{w}} )$$

where, Z_{w}=Zone width in display pixel
Z=number of zones
Z_{ID}=zone identifier (e.g., 0 thru Z−1)
Dₓ=display pixel coordinates in the x-axis (e.g., midpoint or corners of face boundary)
Dₕ=horizontal display resolution (e.g., total pixels in the x-axis)

It should be noted, the INT function returns the integer portion of a number.

The corresponding zone is reserved for the current face, at step 355. Specifically, it is determined whether the zone is free and available for presenting the content targeted for the audience member associated with the current face. A zone reservation table may be implemented to maintain a list of zone identifiers, and a face ID to which the zone is assigned. Once the zone has been assigned to a face ID, the content targeted to that face ID may be displayed in the particular zone. In one embodiment, when the content has been displayed for a set period of time, the zone assignment may be cleared, allowing other assignments to take place. As such, the reservation table can be thought of as a resource allocation mechanism. Other resource allocation methodologies may be implemented as well.

At step 356, the content display area is determined to be that of the reserved zone. The content may then be presented within the boundaries of the reserved zone.

Fluid Mapping

In another embodiment, fluid mapping is performed to determine the most impactful placement of the content on the display screen. Instead of partitioning the display screen into fixed zones, the content is presented such that it is closest to the audience member.

At step 357, the reference point pixel coordinates (which are in camera coordinates) are mapped to display coordinates. The camera coordinates are translated to display coordinates, for example, by:

$${D}_{x} = \frac{{D}_{h}}{{I}_{h}} * {I}_{x}$$

$${D}_{y} = \frac{{D}_{v}}{{I}_{v}} * {I}_{y}$$

where, Dₓ=x-axis pixel coordinate for the display
   D_{y}=y-axis pixel coordinate for the display
Iₓ=x-axis pixel coordinate for the camera image
I_{y}=y-axis pixel coordinate for the camera image
   Dₕ=horizontal display resolution
      Dᵥ=vertical display resolution
   Iₕ=horizontal camera resolution
      Iᵥ=vertical camera resolution

The result is a display coordinate (x, y). At step 358, the content display area is determined to be that of the display coordinate. The content may then be presented on the display screen such that it is centered on the display coordinate (x, y). As such, instead of fixed zones, fluid mapping enables the content to be placed on the display screen in the same relative location at which the face appears in the image.

Both fixed zones and fluid mapping allow multiple audience members to be serviced at the same time, since the entire display screen is not occupied by a single piece of content.

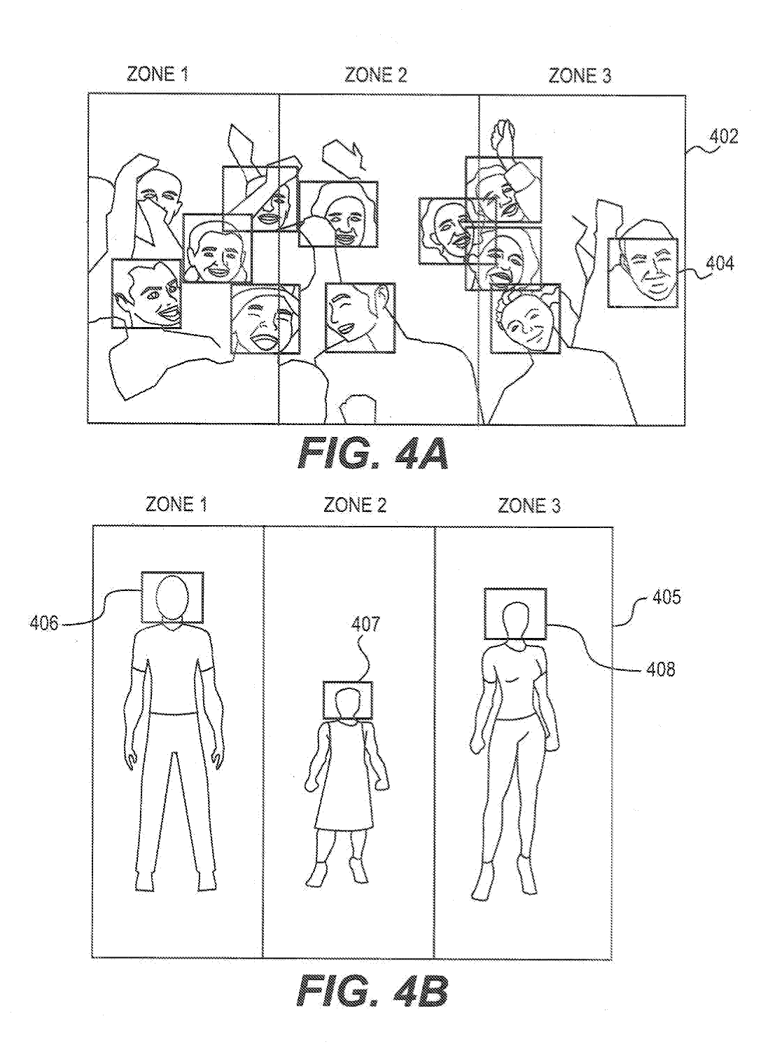

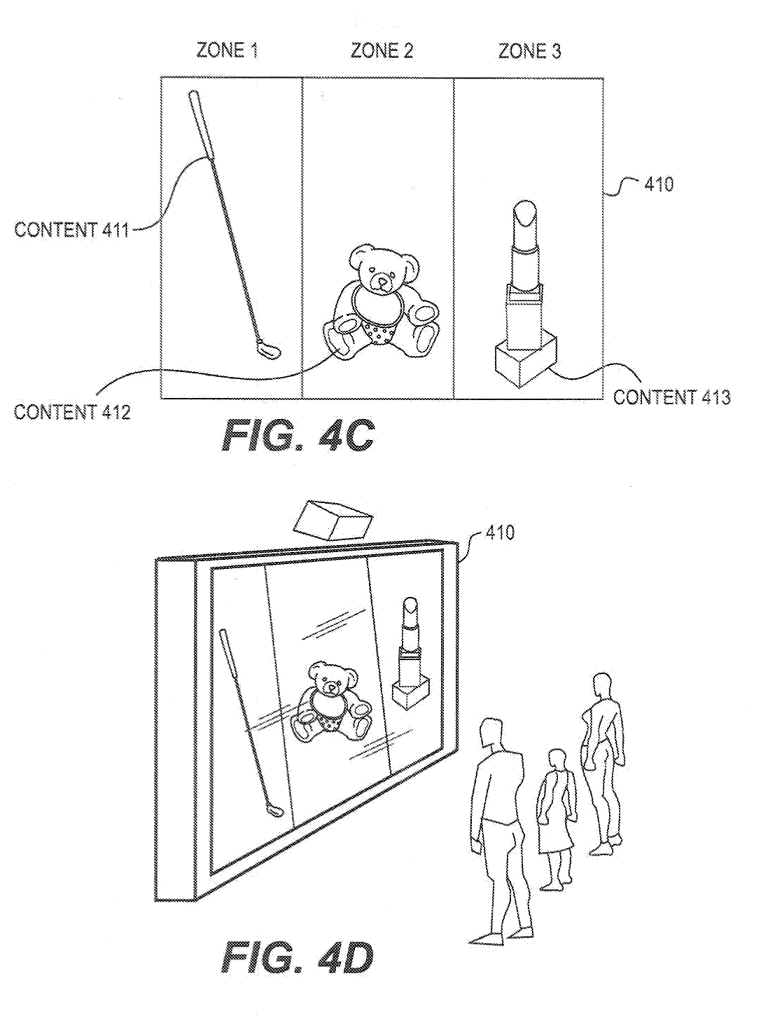

FIG. 4A is a diagram illustrating zone recognition in accordance with an embodiment. Image 402 includes multiple faces 404, as indicated by the corresponding bounding rectangles. Some of the detected faces are in zone 1, others are in zone 2, and the remaining faces are in zone 3. By determining in which zone a particular face is located in the camera image, the corresponding zone in the display may be used to present the content that is specifically selected for the audience member. Where there are multiple faces in a single zone, a prioritization scheme may be used to resolve which audience member to serve.

FIG. 4B is another diagram illustrating zone recognition in accordance with an embodiment. Image 405 includes detected faces from a family of three (as indicated by the corresponding bounding rectangles): a father 406, a child 407, and a mother 408. The face 406 of the father is located in zone 1, the face 407 of the child is located in zone 2, and the face 408 of the mother is located in zone 3.

FIG. 4C is diagram illustrating zones of a display screen in accordance with an embodiment. Display screen 410 is an example of how the targeted content may be displayed with the image 405 as an input. In the context of a public shopping mall, display screen 410 is shown as including three zones, each one servicing a distinct set of audience members. Zone 1 presents content 411, which is targeted content for audience members located in zone 1 (i.e., the father). Zone 2 presents content 412 (a children's toy), which is targeted content for audience members located in zone 2 (i.e., the child). Similarly, zone 3 presents content 413, which is targeted content for audience members located in zone 3 (i.e., the mother). As such, multiple audience members are serviced with content that is specifically targeted to each, via a single display. In one embodiment, the number of zones changes depending on the number of users. For example, where there is just one user, the entire display is allocated to that user, where there are two users, the display shows two zones, etc.

FIG. 4D is a perspective diagram of a digital display system with multiple zones in accordance with an embodiment. As shown, the display screen 410 presents the targeted content to the audience members as described in FIGS. 4A and 4B.

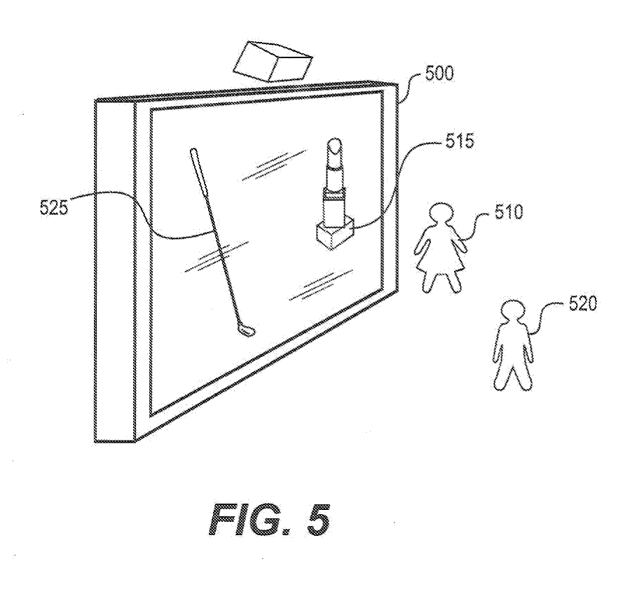

FIG. 5 is a perspective diagram of a digital display system with content displayed via fluid mapping in accordance with an embodiment. Audience member 510 is shown as standing directly facing the right section of the display screen 500. Without the use of fixed zones, the display screen 500 presents the content 515 targeted to audience member 510 such that it is positioned closest to the audience member 510. Likewise, the content 525 is presented such that it is positioned closest to audience member 520. As such, multiple audience members may be serviced with content that is specifically targeted to each, via a single display.

Zone Configuration

Typically, displays and cameras have different resolutions. In many scenarios, it is the display view with the greater level of resolution. For example, a liquid-crystal display (LCD) television has a pixel resolution of 1920×1080, whereas many cameras have less with respect to image resolution. As described herein, users define boundaries of the zones in the camera view, display view, and/or mapping between the camera view and display view.

FIG. 6A is a diagram illustrating zone configuration in accordance with an embodiment. A two-dimensional zone configuration may include defining boundaries of zones in a camera view 610 and a display view 620. Specifically, a boundary (e.g., bottom left camera coordinate and top right camera coordinate) of a zone in the camera view is determined, for example by a user drawing a rectangle that represents the zone via an interface of the camera view. Other zones in the camera view are defined similarly.

In one embodiment, the corresponding zones in the display view 620 are also user-defined. In another embodiment, the corresponding zones in the display view 620 are determined by translating the camera coordinates of each zone to display coordinates. The Table 1 can be generated by the user's selection of zones using an interface for the camera view and/or display view.

FIG. 6B is a diagram illustrating a two-dimensional zone, multiple display floor plan 604 in accordance with an embodiment. As shown, a camera 602 is positioned near a display device, which is made up of independent displays 606, 607, and 608. The camera 602 is oriented toward an audience (including member 603), who are gathered in an audience area within the field of view 601 of the camera 602. Each of the independent displays 606, 607, and 608 corresponds to a distinct region of an image. For example, display 606 corresponds to zone 1 in camera coordinates of floor plan 604, display 607 corresponds to zone 2 in camera coordinates, and display 608 corresponds to zone 3 in camera coordinates.

In one embodiment, the camera 602 captures an image of an audience, which includes member 603. It is determined that member 603 is within zone 2 in the camera coordinates, by determining the bounding rectangle of the face of member 603 in the camera coordinates. The bounding rectangle is expressed using (x,y) coordinates, i.e., a two-dimensional coordinate. When an advertisement is selected, it is presented to the member 603 on display 607 which services zone 2 of floor plan 604.

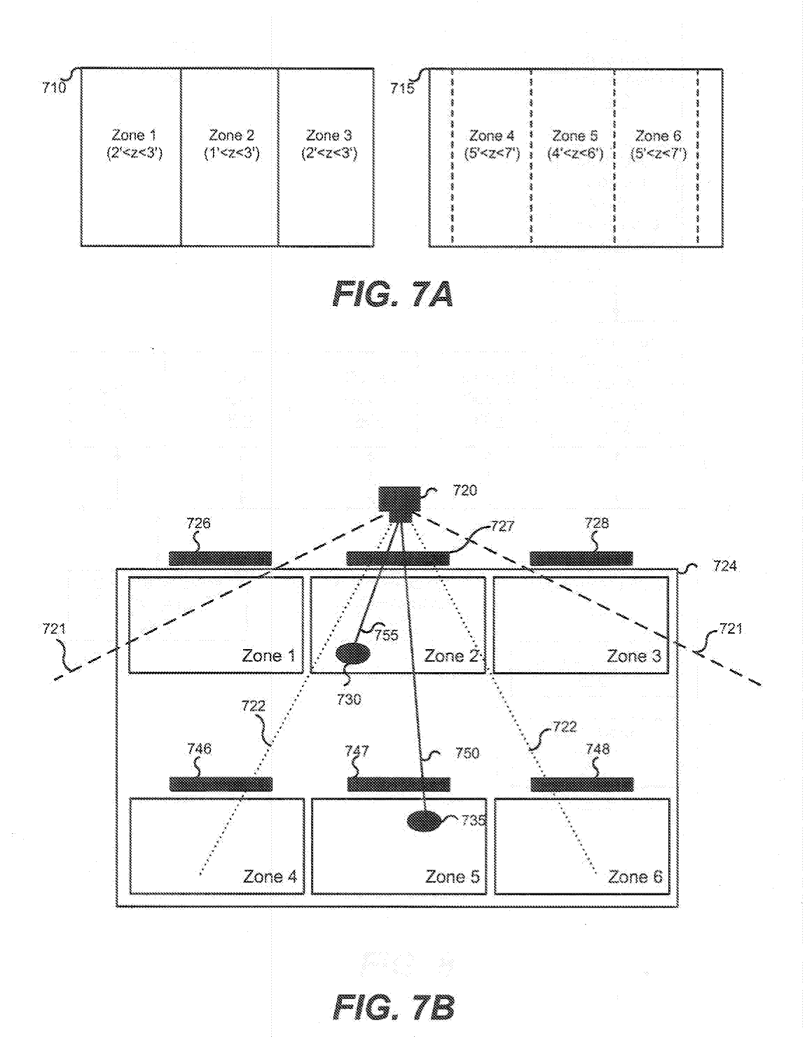

FIG. 7A is diagram illustrating three-dimensional zone, multiple display configuration in accordance with an embodiment. A three-dimensional zone configuration may include defining boundaries of zones in multiple camera views, such as a camera view 710 and a camera view 715. Specifically, a boundary is defined using a third coordinate (i.e., z coordinate) which sets out the distance of an audience member to a camera. The z coordinate may be used, for example, where multiple rows of displays are deployed in a display system.

In one embodiment, zones 1-3 are within one field of view, and zones 4-6 are in another field of view of the camera. Zone 1 in camera view 710 is defined in z coordinates as a member being within two and three feet from the camera. Other zones are defined similarly.

FIG. 7B is a diagram illustrating a three-dimensional, multiple display floor plan 724 in accordance with an embodiment. As shown, a camera 720 is positioned near a display device, which is made up of independent displays 726, 727, and 728, in one horizontal row, and independent displays 746, 747, and 748 in another horizontal row. The display screens of each display are faced in the same direction of the camera 720.

The camera 720 is oriented toward an audience (including member 730), who is gathered in an audience area within the field of view 721 of the camera 720, and an audience (including member 735) who is gathered in an audience area within the field of view 722.

Each of the independent displays 726-728 and 746-748 corresponds to a distinct region of an image. For example, display 726 corresponds to zone 1 in camera coordinates of floor plan 724, display 727 corresponds to zone 2 in camera coordinates, and display 728 corresponds to zone 3 in camera coordinates. Furthermore, display 746 corresponds to zone 4 in camera coordinates of floor plan 724, display 747 corresponds to zone 5 in camera coordinates, and display 748 corresponds to zone 6 in camera coordinates.

In one embodiment, the camera 720 captures an image of an audience, which includes member 730. It is determined that member 730 is within zone 2 in the camera coordinates, by determining the bounding rectangle of the face of member 730 in the camera coordinates. The bounding rectangle is expressed using (x,y) coordinates, i.e., a two-dimensional coordinate. For an image which includes member 735, it is determined that the bounding rectangle using two-dimensional coordinates (x,y) is the same as that of member 730. As such, the ad targeted for member 735 may be presented on display 727, rather than display 747.

By using the z coordinate, the zone location of member 735 may be correctly identified as zone 5 which corresponds to display 747, using a distance 750 measurement of member 735 to the camera 720. Likewise, the zone location of member 730 may be correctly identified as zone 2 which corresponds to display 727, using a distance 755 measurement of member 730 to the camera 720.

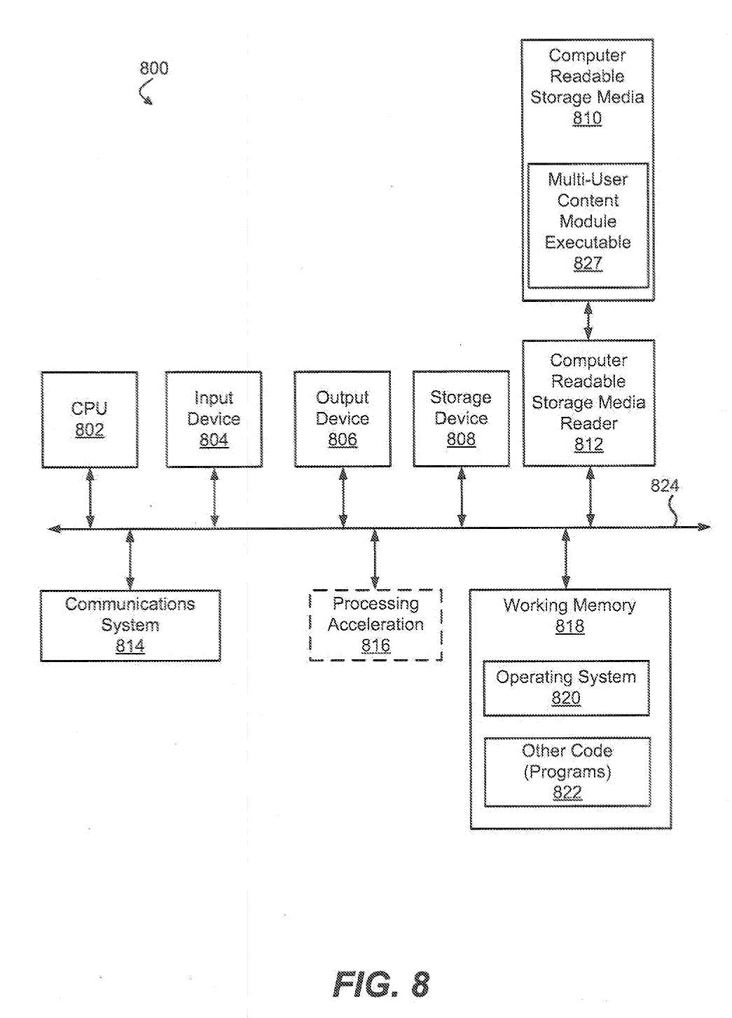

FIG. 8 illustrates a computer system in which an embodiment may be implemented. The system 800 may be used to implement any of the computer systems described above. The computer system 800 is shown comprising hardware elements that may be electrically coupled via a bus 824. The hardware elements may include at least one central processing unit (CPU) 802, at least one input device 804, and at least one output device 806. The computer system 800 may also include at least one storage device 808. By way of example, the storage device 808 can include devices such as disk drives, optical storage devices, solid-state storage device such as a random access memory (“RAM”) and/or a read-only memory (“ROM”), which can be programmable, flash-updateable and/or the like.

The computer system 800 may additionally include a computer-readable storage media reader 812, a communications system 814 (e.g., a modem, a network card (wireless or wired), an infra-red communication device, etc.), and working memory 818, which may include RAM and ROM devices as described above. In some embodiments, the computer system 800 may also include a processing acceleration unit 816, which can include a digital signal processor (DSP), a special-purpose processor, and/or the like.

The computer-readable storage media reader 812 can further be connected to a computer-readable storage medium 810, together (and in combination with storage device 808 in one embodiment) comprehensively representing remote, local, fixed, and/or removable storage devices plus any tangible non-transitory storage media, for temporarily and/or more permanently containing, storing, transmitting, and retrieving computer-readable information (e.g., instructions and data). Computer-readable storage medium 810 may be non-transitory such as hardware storage devices (e.g., RAM, ROM, EPROM (erasable programmable ROM), EEPROM (electrically erasable programmable ROM), hard drives, and flash memory). The communications system 814 may permit data to be exchanged with the network and/or any other computer described above with respect to the system 800. Computer-readable storage medium 810 includes a multi-user content module executable 827.

The computer system 800 may also comprise software elements, which are machine readable instructions, shown as being currently located within a working memory 818, including an operating system 820 and/or other code 822, such as an application program (which may be a client application, Web browser, mid-tier application, etc.). Alternate embodiments of a computer system 800 may have numerous variations from that described above. For example, customized hardware might also be used and/or particular elements might be implemented in hardware, software (including portable software, such as applets), or both. Further, connection to other computing devices such as network input/output devices may be employed.

The specification and drawings are, accordingly, to be regarded in an illustrative rather than a restrictive sense. It will, however, be evident that various modifications and changes may be made.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example of a generic series of equivalent or similar features.

What is claimed is:

1. A method for providing content, the method comprising:
determining, by a computing device, an image;
determining a set of faces in the image, wherein each face corresponds with a user of a display screen;
for each face in the set of faces,
determining an identifier for the face;
selecting content targeted for the face;
determining a location of the face within the image; and
using the face location, determining a location on the display screen to provide a visualization of the targeted content.

2. The method of claim 1, wherein determining the identifier comprises:
determining whether the face is previously known;
assigning a new identifier to the face where the face is not previously known; and
assigning to the face an identifier of a historical face where the face is previously known.

3. The method of claim 2, wherein determining whether the face is previously known comprises:
determining a location of the face within the image;
comparing the location of the face to a location of a historical face of a set of historical faces; and
determining the location of the face overlaps with the location of the historical face.

4. The method of claim 2, wherein determining whether the face is previously known comprises:
determining a unique signature of the face using facial features of the face;
comparing the unique signature of the face to a unique signature of a historical face of a set of historical faces; and
determining the face is previously known where the unique signature of the face matches the unique signature of the historical face.

5. The method of claim 1, wherein selecting content targeted to the face comprises:
extracting a facial feature from the face;
mapping the facial feature to an attribute; and
selecting content based on the attribute.

6. The method of claim 5, wherein an attribute is one of age, gender, and ethnicity.

7. The method of claim 1, wherein determining the location on the display screen comprises:
determining the display screen is partitioned into a plurality of zones;
determining a reference point of the face in camera coordinates of the image;
identifying a zone of the plurality of zones based on the reference point coordinates.

8. The method of claim 7, wherein the reference point coordinates map to the zone of the plurality of zones.

9. The method of claim 7, wherein each zone of the plurality of zones services a distinct subset of the set of faces.

10. The method of claim 7, wherein each zone of the plurality of zones corresponds with a range of camera coordinates and a range of display coordinates.

11. The method of claim 7, further comprising:
reserving the identified zone; and
displaying the selected content in the reserved zone.

12. The method of claim 1, wherein determining the location on the display screen comprises:
determining a reference point of the face in camera coordinates of the image;
translating the reference point of the face in camera coordinates to display coordinates; and
displaying the selected content using the camera coordinates.

13. A system for providing targeted content, comprising:
an imaging device to capture an image of an audience;
a facial detection module to determine a set of faces in the image of the audience, wherein each face corresponds with a user of a display;
a location mapping module to: for each face in the set of faces,
determine an identifier for the face;
select content targeted for the face;
determine a location of the face within the image; and
using the face location, determine a location on the display to provide a visualization of the targeted content.

14. A non-transitory computer-readable medium storing a plurality of instructions to control a data processor to provide targeted content, the plurality of instructions comprising instructions that cause the data processor to:
receive an image;
determine a set of faces in the image, wherein each face corresponds with a user of display screen;
for each face in the set of faces,
determine an identifier for the face;
select content targeted for the face;
determine a location of the face within the image; and
using the face location, determine a location on the display screen to provide a visualization of the targeted content.

15. The non-transitory computer-readable medium of claim 14, wherein the instructions that cause the data processor to determine the identifier comprise:
instructions that cause the data processor to determine whether the face is previously known;
instructions that cause the data processor to assign a new identifier to the face where the face is not previously known; and
instructions that cause the data processor to assign to the face an identifier of a historical face where the face is previously known.

16. The non-transitory computer-readable medium of claim 15, wherein the instructions that cause the data processor to determine whether the face is previously known comprise:
instructions that cause the data processor to determine a location of the face within the image;
instructions that cause the data processor to compare the location of the face to a location of a historical face of a set of historical faces; and
instructions that cause the data processor to determine the location of the face overlaps with the location of the historical face.

17. The non-transitory computer-readable medium of claim 14, wherein the instructions that cause the data processor to select content targeted to the face comprise:
instructions that cause the data processor to extract a facial feature from the face;
instructions that cause the data processor to map the facial feature to an attribute; and
instructions that cause the data processor to select content based on the attribute.

18. The non-transitory computer-readable medium of claim 17, wherein an attribute is one of age, gender, and ethnicity.

19. The non-transitory computer-readable medium of claim 14, wherein the instructions that cause the data processor to determine the location on the display screen comprise:
instructions that cause the data processor to determine the display screen is partitioned into a plurality of zones;
instructions that cause the data processor to determine a reference point of the face in camera coordinates of the image;
instructions that cause the data processor to identify a zone of the plurality of zones based on the reference point coordinates.

20. The non-transitory computer-readable medium of claim 19, wherein each zone of the plurality of zones corresponds with a range of camera coordinates and a range of display coordinates.
